(19) United States
(12) Patent Application Publication
(10) Pub. No.: US 2002/0053116 A1
(43) Pub. Date: May 9, 2002

(54) Ezi handle

(76) Inventor: Bernard Martin Knowlton, Santa Barbara, CA (US)

Correspondence Address: BERNARD M. KNOWLTON, PO BOX 6464, SANTA BARBARA, CA, 93160, US

(21) Appl. No.: 09/974,081

(22) Filed: Oct. 11, 2001

Related U.S. Application Data
(60) Provisional application No. 60/238,636, filed on Oct. 10, 2000.

(51) Int. Cl. E05B 1/00

(52) U.S. Cl. 16/110.1

(57) ABSTRACT

This invention facilitates the carrying of containers of drinking water or other liquids/juices/sodas by designing an Ezi-Handle which attaches firmly to the neck of the container and provides a convenient method of carrying the container by the use of finger[s]. This handle provides a carrying method which frees up the carrying hand to perform other tasks. Otherwise carrying the container without the handle requires the use of the carrying hand, reducing the effective use of two hands down to one hand which is patently undesireable.

### BACKGROUND OF THE INVENTION

The field of the present invention relates to a handle made from soft, flexible plastic that fits snugly around the top of a bottle of the type that is in common usage for drinking bottles containing water, soft drinks, juices and other liquids. The smaller hole fits down over the top of the container after the cap is removed and screwed in a clockwise fashion over the threads to arrive in a final position at the end of the small neck. The larger end of the handle fits over one's finger[s] to the carrier of the bottle which provides a very efficient manner to carry the bottle and very importantly frees up that hand for other purposes. Without the handle, there is no convenient manner to carry the bottle without tying up one hand exclusively for carrying the bottle.

The inventor has no knowledge of a similar device that is designed specially for this use. There are other carriers available but they are cumbersome, bulky and undesireable.

### SUMMARY OF THE INVENTION

The present invention is a simple device made from soft flexible plastic approximately 0.1 cm in thickness, similar to such plastic now used by the bottlers in many of their 6-pack cartons. The invention can be readily applied and removed from the bottle for continued usage.

### BRIEF DESCRIPTION OF THE DRAWINGS

FIG. 1 is a front view of the invention illustrating the relationship between the smaller opening that screws over the top of the bottle and the larger opening which serves as the opening for one or two fingers of the hand of the individual.

FIG. 2 is a side view of the invention showing the thickness as approximately 0.1 cm.

FIG. 3 is a bottom view of the invention showing the thickness as approximately 0.1 cm.

FIG. 4 is a side view of the handle attached to the bottle.

FIG. 5 is a front view of the handle attached to the bottle.

### DETAILED DESCRIPTION OF THE EMBODIMENT

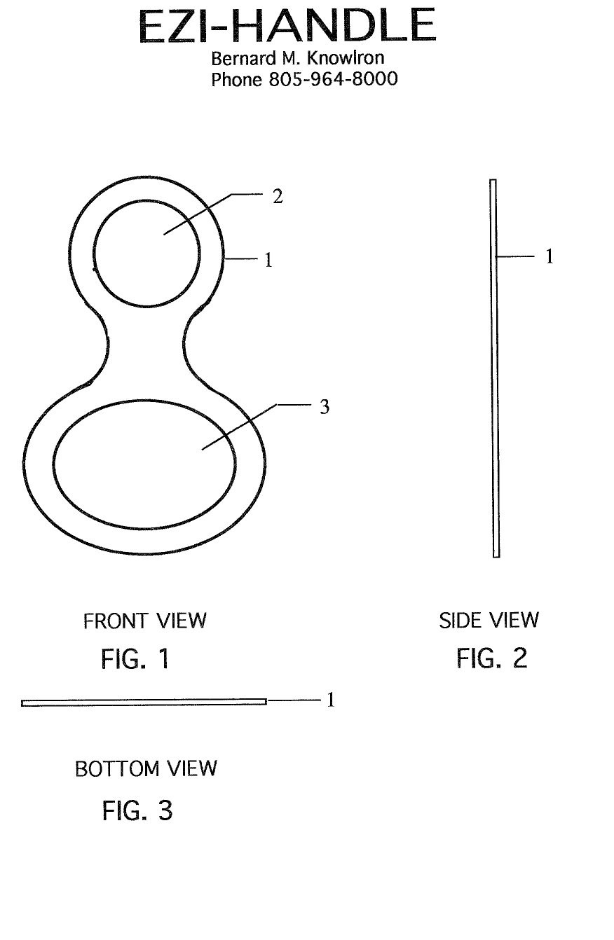

FIG. 1 shows the front view with 1 indicating the entire handle. 2 indicates the smaller opening that screws down over the threads that hold the cap 6 on the bottle 5. 3 indicates the larger opening into which the individual inserts his/her finger[s] for the carrying position.

FIG. 2 shows the side view.

FIG. 3 shows the bottom view.

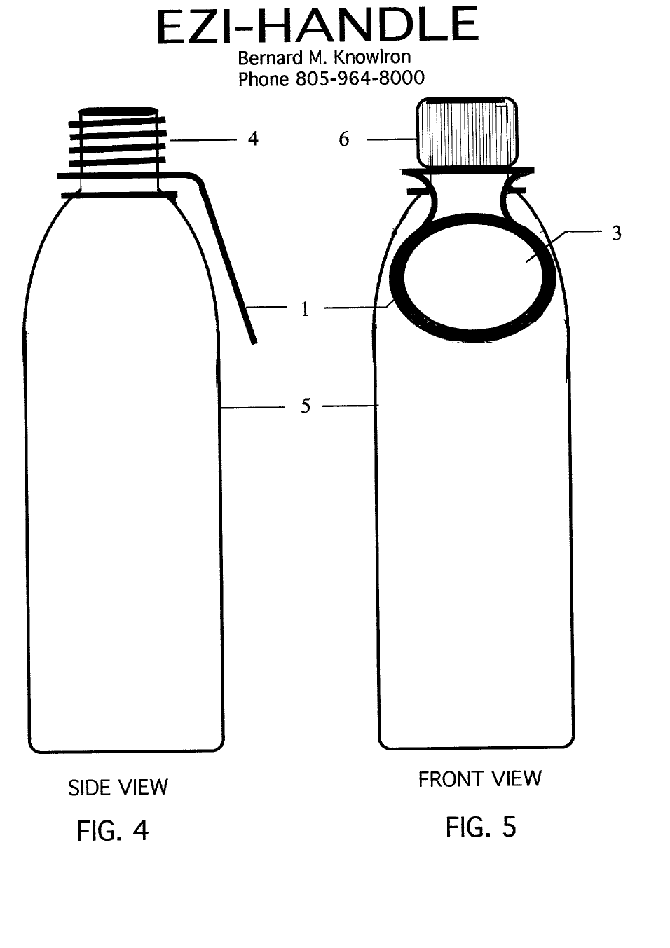

FIG. 4 shows the side view with the handle 1 attached down over the screw threads 4 of the bottle 5.

FIG. 5 shows the front view with handle 1 installed over the threads 4 and with the cap 6 now screwed down in it's closed position.

### DETAILED DESCRIPTION OF THE INVENTION

This invention is designed to enable users to carry drinking water and other liquids in a very convenient and comfortable manner by using a plastic handle attached to the usual type drinking container. The handle is shaped with two openings, a smaller one to fit over and be screwed down onto the neck of the water container, the larger opening is designed with an eliptical opening to provide a grip for the user's finger[s]. The smaller opening can be programed to the neck size of any container which makes the handle extremely versatile since the market uses several neck sizes.

The invention consists of a single object made from soft, flexible plastic in order to be comfortable to the user's fingers, soft so the user's finger[s] will not tire or be sore with lengthy time in use, flexible so handle will bend in the upright position when in use for the carrying position and will naturally tend to bend downward when in the non-use or storage situation. The plastic can be laser-cut or punch-cut or with other methods out of flat sheets of the plastic. The design permits use of low cost materials. It has easy storage and shipment features plus it can be removed from bottle and used on another one of the same neck size.

1. What I claim as my invention is a object that makes it convenient and comfortable for individuals to carry bottles of water or other liquids with a plastic handle designed with a smaller opening to be firmly affixed to the neck of the bottle and with a larger elliptical opening where the user's finger[s] can be inserted.

2. What I also claim is that the design can be easily manufactured to fit larger or smaller neck sizes by increasing the size desired to fit either larger and smaller neck sizes
